(19) United States
(12) Patent Application Publication
(10) Pub. No.: US 2012/0079300 A1
(43) Pub. Date: Mar. 29, 2012

(54) ELECTRONIC APPARATUS

(75) Inventors: Izumi Hachisuga, Higashiosaka-shi (JP); Kazunori Miyata, Shijonawate-shi (JP)

(73) Assignee: SANYO ELECTRIC CO., LTD., Moriguchi-shi, Osaka (JP)

(21) Appl. No.: 13/376,627

(22) PCT Filed: May 25, 2010
(86) PCT No.: PCT/JP2010/058817

§ 371 Date: Dec. 7, 2011

(30) Foreign Application Priority Data
Jun. 9, 2009 (JP) 2009-138290

(51) Int. Cl. G06F 1/32

(52) U.S. Cl. 713/320

(57) ABSTRACT

A power-supply connection portion connects a power supply and a main body device. Operation information for operating the apparatus main body is stored in a volatile memory. A power feeder feeds power fed from the power supply, to the volatile memory. A non-operation state request receiver receives a non-operation state request for moving the apparatus main body from an operation state to a non-operation state. When the non-operation state request is received by the non-operation state request receiver, a power-feeding controller performs control such that the power feeder feeds the power to the volatile memory for a predetermined period. A mode determiner determines a mode of the non-operation state request. A changer is provided with a setter which sets the predetermined period depending on the mode determined by the mode determiner.

### TECHNICAL FIELD

The present invention relates to an electronic apparatus, and more particularly, relates to an electronic apparatus which controls power feeding to a device other than a main device of the apparatus main body when the power feeding to the main device of the apparatus main body is stopped.

### BACKGROUND ART

Conventionally, for example, in an electronic apparatus such as a digital camera, a process is executed in which when a power-supply button is off-manipulated by a user, a current state is changed from a power-on state in which power is fed to the entire apparatus to a power-off state in which power is not fed to a main device of the apparatus except for some devices (for example, a sub microcomputer which detects depressing of a manipulation button including the power-supply button).

However, in the electronic apparatus such as a digital camera, it is necessary to execute a process of loading (developing), to a volatile memory such as an SDRAM, information (including setting information necessary for a photographing process) required for an activation and an operation of the apparatus main body that is stored in the nonvolatile memory, after moved from the above-described power-off state to the power-on state.

When a user uses such an electronic apparatus, the shorter a time period from the movement from the power-off state of the apparatus main body to the power-on state thereof to the actual activation of the apparatus main body, the more convenient usability becomes. Thus, it is demanded to shorten a time period from the movement from the power-off state to the power-on state until the activation.

### SUMMARY OF INVENTION

### Technical Problem

In the apparatus described above, if a battery charge amount at the time of receiving a stop command is lower than a threshold value, the current state is moved to a shutdown state in which power is not fed to a circuit system unnecessary to operate during the stop, and if the battery charge amount is higher than the threshold value, the current state is moved to a standby state in which a process necessary during the activation is performed in advance in the middle of the stop in order to shorten an activation processing time at the time of a reactivation, and the state that is established at this time is maintained, thereby shortening a system activation time and normally starting-up the system.

However, the above-described apparatus inevitably becomes under a standby state if the battery charge amount at the time of receiving the stop command is higher than the threshold value, and therefore, power is fed to the volatile memory even when a user does not plan to perform an operation for the reactivation next time. As a result, unnecessary power is fed to the volatile memory. In consideration of such a case, it is possible to conceive a technique of shortening a time period for feeding power to the volatile memory at the time of receiving the stop command so that the unnecessary power is prevented from being fed to the volatile memory. However, it is necessary for a user to issue a user's reactivation command in the said time period, and if it is not possible to issue the command within the time period, then the result is that the loading process and the like are performed as described above, and thus, it takes time until the reactivation.

The present invention solves the above-described problems and provides an electronic apparatus by which it is possible to stop, when an instruction to stop a function of one portion (main device) of an apparatus main body is issued, feeding power to a device relating to the function, and to feed the power to a volatile memory for an optimal period.

### Solution to Problem

An electronic apparatus according to the invention of the subject application includes: a volatile memory which stores operation information for operating an apparatus main body; a power feeder which feeds first power for retaining the operation information stored in the volatile memory and second power for maintaining an operation state to the apparatus main body; a request receiver which receives a non-operation state request for moving the apparatus main body from the operation state to a non-operation state in which one portion of the apparatus main body is not operated; a power-feeding controller which controls the power feeder such that the first power only is fed for a predetermined period when the non-operation state request is received by the request receiver; a mode determiner which determines a mode of the non-operation state request; and a setter which sets the predetermined period depending on the mode determined by the mode determiner.

Based on the electronic apparatus according to the present invention, when an instruction to stop a function of one portion (main device) of an apparatus main body is issued, it is possible to stop feeding the power to a device relating to the function and to feed the power to a volatile memory for an optimal period

The above described object, other objects, features, and advantages of the present invention will become more apparent from the following detailed description of the embodiment when taken in conjunction with the accompanying drawings.

### BRIEF DESCRIPTION OF DRAWINGS

FIG. 1 is a block diagram showing a digital camera according to this embodiment

FIG. 2 is a flowchart showing one portion of operations in a sub CPU applied to this embodiment.

FIG. 3 is a flowchart showing one portion of operations in a main CPU applied to this embodiment.

FIG. 4 is a flowchart showing another portion of operations in the main CPU applied to this embodiment.

FIG. 5 is a flowchart showing one portion of operations in a power-supply control portion applied to this embodiment.

### DESCRIPTION OF EMBODIMENTS

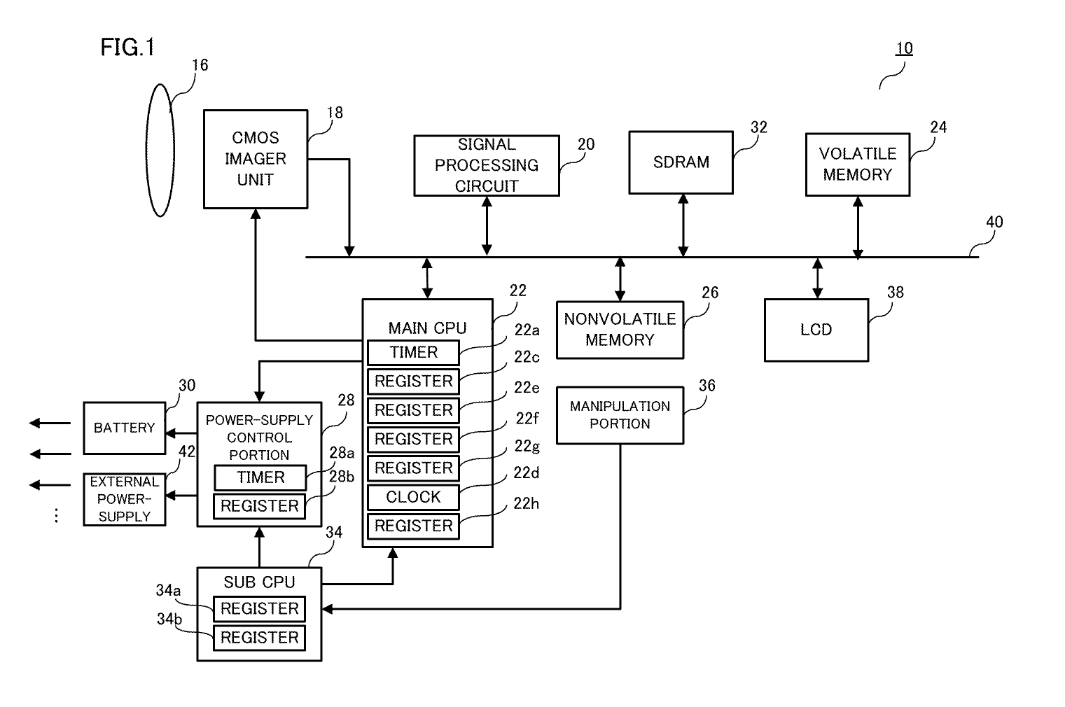

Hereinafter, as one embodiment of an electronic apparatus of the present invention, an embodiment carried out for a digital camera 10 will be described along with the drawings. FIG. 1 shows a block diagram of the digital camera 10. The digital camera 10 includes an optical lens 16 and an aperture (not shown). An optical image of a subject is captured to a CMOS imager unit 18 through the optical lens 16 and the aperture controlled by a motor drive portion (not shown) in response to an instruction from a main CPU 22. Then, by a capturing pulse applied by a timing generator (not shown) connected to the main CPU 22, one frame of a digital imaging signal is outputted from the CMOS imager unit 18. Herein, the CMOS imager unit 18 amplifies electric charges accumulated in each pixel, reads them out as a signal from each pixel through a wiring line, and subjects the signal to a gain adjustment, a clamp process, and an A/D conversion process. The digital imaging signal that has undergone the processes has any one of colors signals, i.e., R, G, and B, for each pixel, and is temporarily stored in an SDRAM 32 via a bus 40 by control of the main CPU 22.

The digital imaging signal temporarily stored in the SDRAM 32 is inputted to a signal processing circuit 20 by control of the main CPU 22. In the signal processing circuit 20, a color separation process is performed on the inputted digital imaging signal, and furthermore, by a YUV conversion, the resultant signal is converted into Y, U, and V signals. Then, the digital image signal converted in the signal processing circuit 20 is stored in the SDRAM 32 again via the bus 40. In this embodiment, a process performed from the digital imaging signal outputted from the above-described CMOS imager unit 18 is subjected to a converting process into the digital image signal by the signal processing circuit 20 until the resultant signal is stored in the SDRAM 32 is defined as a photographing process.

Moreover, the digital image signal stored in the SDRAM 32 is outputted to an LCD 38 by control of the main CPU 22. The LCD 38 includes an LCD driver not shown, and the LCD driver converts Y, U, and V signals into an RGB signal, and causes the LCD 38 to display an image signal that is based on the digital image signal.

Furthermore, in a case where a still image is recorded, the digital image signal stored in the SDRAM 32 is subjected to a compression process in a compression/decompression processing portion (not shown) and stored in an internal memory (not shown) as a still image file of a JPEG format. It is noted that in a case where a moving image is recorded, the digital image signal is subjected to a compression process in a compression/decompression processing portion (not shown) and stored in an internal memory (not shown) as a moving image file of an MPEG format.

Also, a manipulation portion 36 is provided with a main switch which switches on/off states (moves a current state from an on state to an off state or from the off state to the on state) of a power feeding from a power supply to a main body of the digital camera 10. It is noted that in this embodiment, a source of the power fed to one or entire portion of the digital camera 10 is a battery 30 or an external power supply 42. The external power supply 42 is, for example, an AC device such as an AC adaptor, and when the external power-supply 42 is connected, a power-supply control portion 28 controls such that power from the external power-supply 42, rather than power from the battery 30, is fed to the digital camera 10.

The manipulation portion 36 is connected to a sub CPU 34, and each manipulation signal including a signal corresponding to the on/off manipulation of the power supply of the main switch is inputted to the sub CPU 34 as a result of the manipulation portion 36 being manipulated. The sub CPU 34 is connected to the main CPU 22 and the power-supply control portion 28, and when the manipulation signal is inputted, the sub CPU 34 transmits each manipulation command to the main CPU 22 and the power-supply control portion 28 with reference to the manipulation signal.

Meanwhile, an operation of the main CPU 22 is executed based on a firmware stored in the volatile memory 24. The firmware is a software, i.e., a program, necessary for activating the main body of the digital camera 20 (a system activation process), which includes the above-described photographing process. Moreover, the firmware is stored in a nonvolatile memory 26, and when the current state is moved from a power-supply sleeping state to a main-power-supply supplying state in response to the power-on manipulation of the main switch, the main CPU 22 develops the firmware in the volatile memory 24.

Herein, in this embodiment, a state in which the power is fed from the power supply only to the sub CPU 34 and the power-supply control portion 28 and the power supply is not provided to devices other than the sub CPU 34 and the power-supply control portion 28 is defined as a power-supply sleeping state, a state in which the power is fed from the power supply only to the power-supply control portion 28, the sub CPU 34, and the volatile memory 24 is defined as a memory-power-supply supplying state, and a state in which the power is fed from the power supply to the entire digital camera 10 is defined as a main-power-supply supplying state.

As a result of user's intentional power-off manipulation of the main switch, the main CPU 22 transitions the current state from the main-power-supply supplying state through the memory-power-supply supplying state to the power-supply sleeping state. In addition, when it is determined by a management of a timer 22a in the main CPU 22 that a manipulation from a user is not performed on the manipulation portion 36 for a predetermined time period, the current state is transitioned from the main-power-supply supplying state through the memory-power-supply supplying state to the power-supply sleeping state (hereinafter, referred to as a “sleep operation”). The power-off manipulation and the sleep operation are a manipulation and an operation for a purpose of turning off the power supply.

Now, the digital camera 10 according to this embodiment calculates a state retaining time T1 of the memory-power-supply supplying state according to Equation 1, for example, based on coefficients α, β, and γ corresponding to the power-off manipulation or the sleep operation by which the transition is triggered and other elements described below.

T1=α*β*γ (Equation 1)

In addition, the state retaining time T1 is measured by a timer 28a in the power-supply control portion 28, and a time-up is reached when the state retaining time T1 elapses. When the time-up is reached, the power-supply control portion 28 controls the power supply such that the current state is transitioned from the memory-power-supply supplying state to the power-supply sleeping state.

Hereinafter the coefficients α, β, and γ are described.

The coefficient α is a numerical value corresponding to the trigger for the transition, as described above. The coefficient α is stored in a manipulation lookup table (not shown) in the nonvolatile memory 26, and when the main CPU 22 determines that the current manipulation is the power-off manipulation that serves as the trigger for transition, the coefficient corresponding to the power-off manipulation is stored in a register 22e with reference to the manipulation lookup table. It is noted that in the manipulation lookup table, values corresponding to the power-off manipulation and the sleep operation are arranged. Meanwhile, if the main CPU 22 determines that the current operation is the sleep operation that serves as the trigger for transition, the coefficient corresponding to the sleep operation is stored in the register 22e with reference to the manipulation lookup table.

Specifically, if it is determined that the current manipulation is the power-off manipulation, the main CPU 22 raises an off-manipulation flag F3 that has been stored in a register 22h (F3=1), and if it is determined that the current operation is the sleep operation, the CPU 22 resets the off-manipulation flag F3 (F3=0).

In this case, the coefficient cc corresponding to the power-off manipulation is smaller in value than the coefficient cc corresponding to the sleep operation. This is because when the user turns off the power, which arises from the power-off manipulation, the user intentionally turns off the power, and therefore, there is a low possibility that the user performs the power-on manipulation immediately after turning off the power and uses the digital camera 10. On the other hand, when the user turns off the power, which arises from the sleep operation, the user unintentionally turns off the power, and therefore, there is a high possibility that the user performs the power-on manipulation by manipulating the main switch immediately after turning off the power and uses the digital camera 10.

Therefore, when the power-off manipulation is performed, if the state retaining time T1 is shortened, then unnecessary power is not fed. This serves to achieve power-saving. On the other hand, when the sleep operation is executed, if the state retaining time T1 is extended, then it is possible to shorten the activation time of the digital camera 10, and when the power-on manipulation of the main switch is performed within the state retaining time T1, it is possible to promptly execute the firmware stored in the volatile memory 24, and therefore, it is possible to shorten the activation time of the digital camera 10.

The coefficient β is a numerical value corresponding to a voltage level of a battery 30 if the battery 30 is used as the power supply. The coefficient β is stored in a voltage lookup table (not shown) in the nonvolatile memory 26. It is noted that a value corresponding to the voltage level is arranged in the voltage lookup table. When the voltage level of the battery 30 is detected, the main CPU 22 refers to the voltage lookup table so that the coefficient corresponding to the voltage level is stored in a register 22f.

Furthermore, the coefficient β when the voltage level is high is larger in numerical value as compared to when the voltage level is low. The reason for this is as follows: unlike when the voltage level is low, i.e., when the remaining amount of the battery 30 is small, when the voltage level is high, i.e., when the remaining amount of the battery 30 is large, there is a sufficient remaining amount of the battery 30, and thus, the state retaining time T1 may be extended. In this case, when the power-on manipulation on the main switch is performed within the state retaining time T1, if the firmware stored in the volatile memory 24 is promptly executed, then it is possible to shorten the activation time of the digital camera 10. Moreover, when the voltage level is low, it is possible to extend the lifetime of the battery 30 by shortening the state retaining time T1 to achieve power-saving.

Furthermore, when the external power-supply 42 is used as the power supply, the power is fed to the main CPU 22 without interruption. Therefore, the state retaining time T1 is set to infinity without detecting the coefficients α and β.

The coefficient γ is a numerical value corresponding to a current time set to the digital camera 10. The coefficient γ is stored in a time lookup table (not shown) in the nonvolatile memory 26. It is noted that a value corresponding to a time is arranged in the time lookup table. When the current time is detected from a clock 22d, the main CPU 22 refers to the time lookup table and stores the coefficient corresponding to the detected time in a register 22g.

Moreover, the coefficient γ for a midnight time is smaller in numerical value as compared to the coefficient γ that is not for a midnight time but for a time at which user's activity is relatively vigorous. This is because as compared to the midnight at which the time is detected, the user may use the digital camera 10 more frequently during a time during which the user's activity is relatively vigorous, rather than at midnight. Thus, if the state retaining time T1 is extended, then when the power-on manipulation of the main switch is performed within the state retaining time T1, it is possible to shorten the activation time of the digital camera 10 by promptly executing the firmware stored in the volatile memory 24. In addition, when the time is detected at midnight, if the state retaining time T1 is shortened to achieve the power-saving, then it is possible to extend the lifetime of the battery 30.

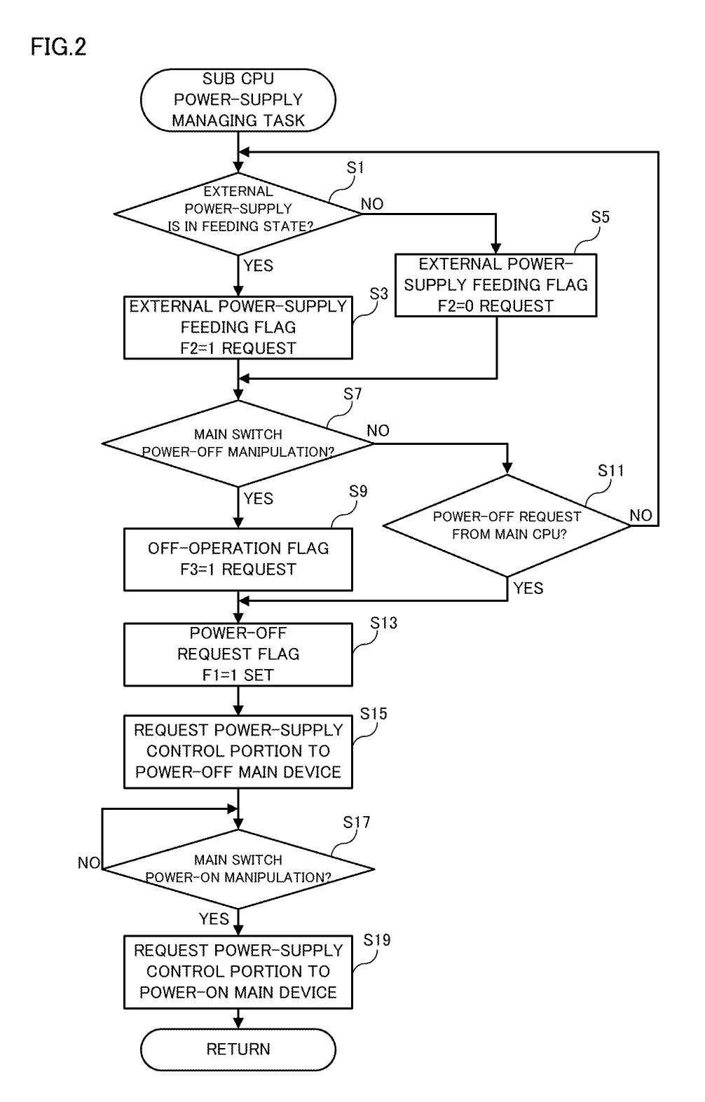

The control such that the current state is transitioned from the main-power-supply supplying state through the memory-power-supply supplying state to the power-supply sleeping state as a result of the above-described power-off manipulation or the sleep operation being performed is realized by respectively executing a program developed from the nonvolatile memory 26 to the volatile memory 24 by using microcomputers (not shown) of the main CPU 22, the sub CPU 34, and the power-supply control portion 28. In addition, a multitasking environment is constructed in the digital camera 10, and thus, the main CPU 22 is capable of performing a plurality of tasks at the same time. Hereinafter, a power-supply managing task, a sleep transition task, a power-feeding-time calculating task, and a power-supply control task respectively executed by microcomputers (not shown) of the sub CPU 34, the main CPU 22, and the power-supply control portion 28 are described with reference to FIGS. 2 to 5.

FIG. 2 shows a flowchart of the power-supply managing task executed by the sub CPU 34. In a step S1, the sub CPU 24 determines whether or not the power is fed from the external power-supply 42 by monitoring the power-supply control portion 28. If YES is determined in the step S1, the process advances to a step S3 so as to transmit a request command for raising an external power feeding flag F2 (F2=1) stored in a register 22c to the main CPU 22, and then, the process advances to a step S7. If NO is determined in the step S1, the process advances to a step S5 so as to transmit a request command for resetting the external power feeding flag F2 (F2=0) stored in the register 22c to the main CPU 22, and then, the process advances to the step S7.

In the step S7, it is determined whether or not the power-off manipulation has been performed as a result of the main switch being manipulated by the user. If YES is determined in the step S7, the process advances to a step S9 so as to transmit a request command for raising the off-manipulation flag F3 (F3=1) stored in a register 22h to the main CPU 22, and then, the process advances to a step S13. If NO is determined in the step S7, the process advances to a step S11 so as to determine whether or not the power-off request command has been transmitted from the main CPU 22. The power-off request from the main CPU 22 is performed based on the sleep operation. If NO is determined in the step S11, the process returns to step S1, and if YES is determined, the process advances to a step S13.

In the step S13, a power-off request flag F1 stored in a register 34a is raised (F1=1). Then, the process advances to a step S15 so as to transmit a command corresponding to the power-off instruction to the main device, to the power-supply control portion 28, and then, the process advances to a step S17. In the step S17, it is determined whether or not the power-on manipulation has been performed as a result of the main switch being manipulated by the user, and the determination is repeated until YES is determined. If YES is determined in the step S17, the process advances to a step S19 so as to transmit a command corresponding to the power-on instruction to the main device, to the power-supply control portion 28, and then, the process returns to the step S1.

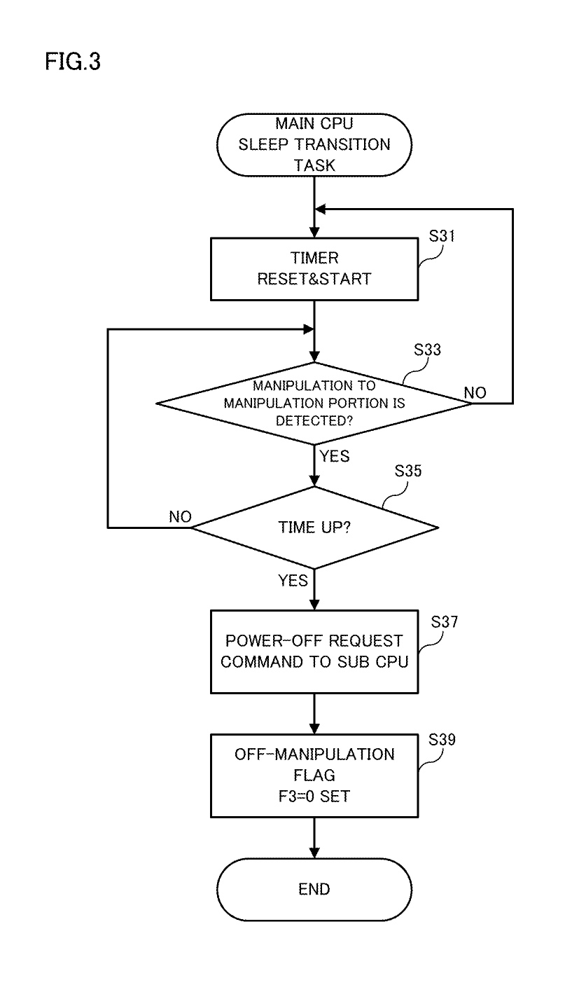

Subsequently, with reference to the flowchart, shown in FIG. 3, of the sleep transition task executed by the main CPU 22, the operation of the digital camera 10 is described.

First, in a step S31, the timer 22a is reset and started. Then, the process advances to a step S33 so as to determine whether or not any manipulation has been performed by the user on the manipulation portion 36, based on the command transmitted from the sub CPU 34. If NO is determined in the step S33, the process advances to a step S31, and YES is determined in the step S33, the process advances to a step S35 in which the timer 22a measures the time for a predetermined time period so as to determine whether or not the time is up. If NO is determined in the step S35, the process advances to a step S33, and if YES is determined in the step S35, the process advances to a step S37. In the step S37, the power-off request command is transmitted to the sub CPU 34, and the process advances to a step S39. In the step S39, the off-manipulation flag F3 stored in the register 22h is reset (F3=0), and this task is ended.

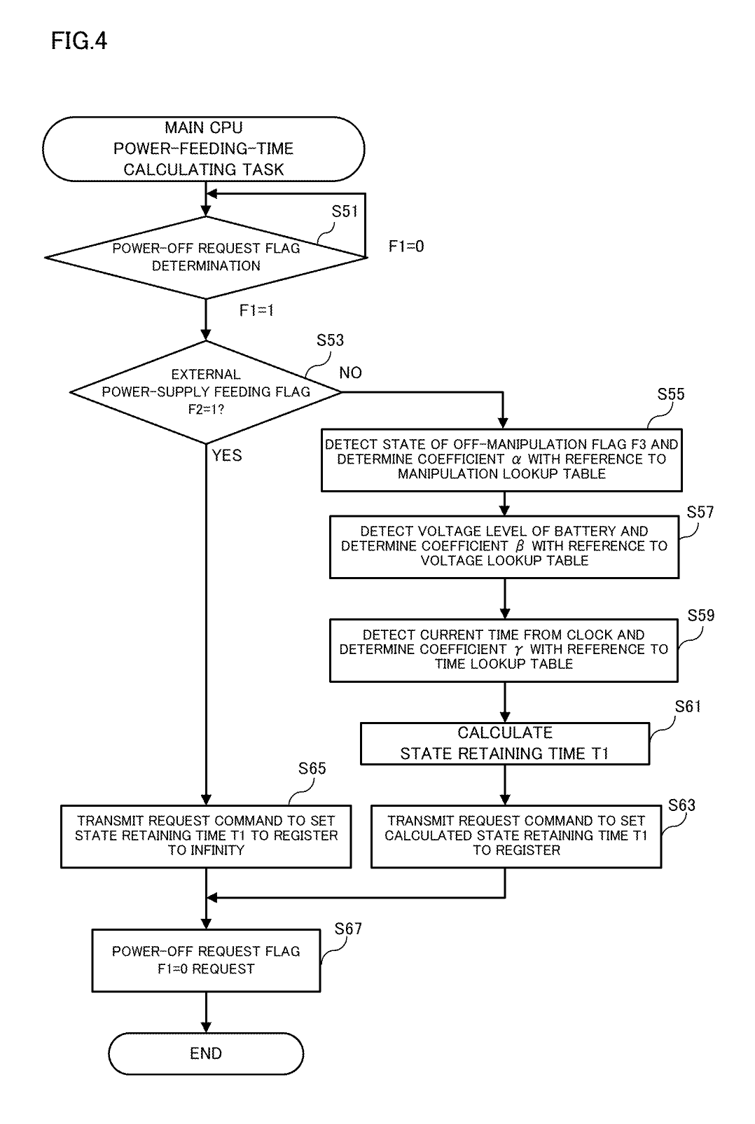

Subsequently, with reference to the flowchart of the power-feeding-time calculating task executed by the main CPU 22 shown in FIG. 4, the operation of the digital camera 10 is described.

In a step S51, the sub CPU 34 is inquired of whether or not the power-off request flag F1 is raised (F1=1 or 0), and the result of a response from the sub CPU 34 is determined. Until it is determined in the step S1 that the power-off request flag F1 is 1, the determination in the step S1 is repeated, and if it is determined that F1 is 1, the process advances to a step S53. In the step S53, it is determined whether or not the external power feeding flag F2 stored in the register 22c is raised (F2=1 or 0). If NO is determined in the step S53, the process advances to a step S55 so as to detect the state of the off-manipulation flag F3, and with reference to the manipulation lookup table, store the coefficient α in the register 22e.

Then, the process advances to a step S57 so as to detect the voltage level of the battery 30, and with reference to the voltage lookup table, store the coefficient β corresponding to the voltage level into the register 22f. Next, the process advances to a step S59 so as to detect the current time from the clock 22d, and with reference to the time lookup table, store the coefficient γ corresponding to the detected time into the register 22g. Then, the process advances to a step S61 so as to calculate the state retaining time T1, and then, the process advances to a step 63. In the step S63, the request command is transmitted in order to set the state retaining time T1 calculated in the step S61 to a register 28b of the power-supply control portion 28, and then, the process advances to a step S67.

If YES is determined in the step S53, the process advances to a step S65 so as to transmit the request command to the power-supply control portion 28 in order that the state retaining time T1 is set to the register 28b to the infinity, and then, the process advances to a step S67.

In the step S67, a request command for resetting the power-off request flag F1 stored in the register 34a (F1=0) is transmitted to the sub CPU 22. Then, this task is ended.

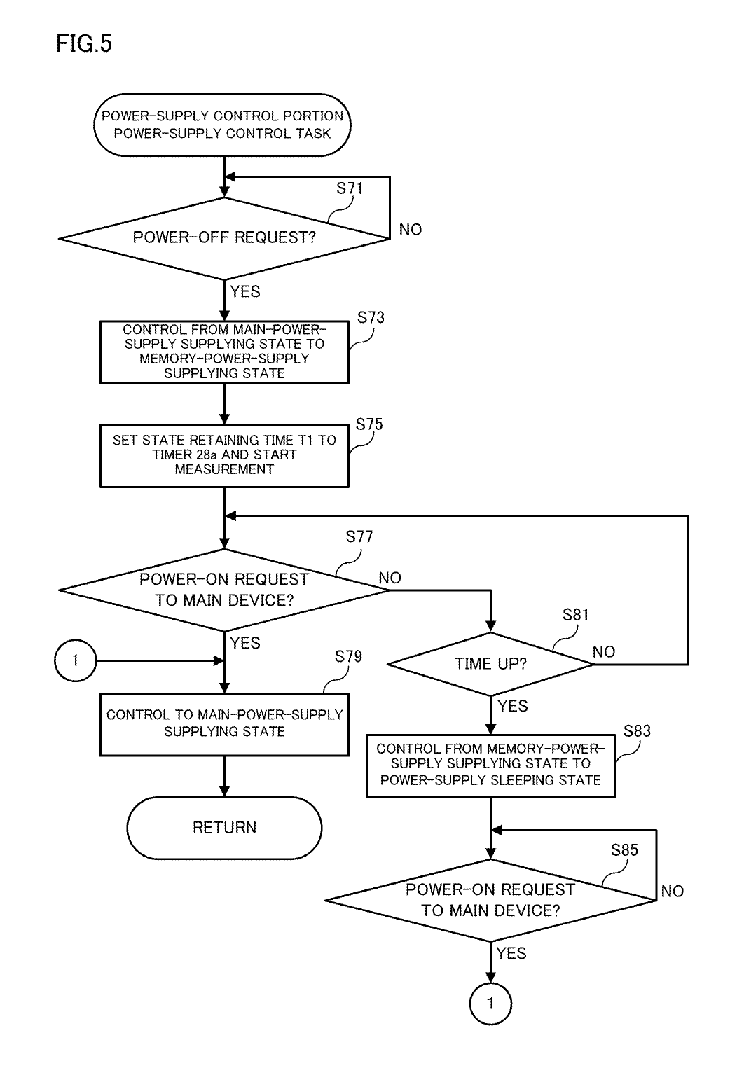

Next, with reference to the flowchart of the power-supply control task executed by a microcomputer in the power-supply control portion 28 shown in FIG. 5, the operation of the digital camera 10 is described.

In a step S71, it is determined whether or not a command corresponding to the power-off instruction to the main device is issued from the sub CPU 34. The determination is repeated until YES is determined in the step S71, and if YES is determined in the step S71, the process advances to a step S73 so as to control the power of the battery 30 or the external power-supply 42 such that the main-power-supply supplying state is transitioned to the memory-power-supply supplying state.

Then, the process advances to a step S75 so as to set the state retaining time T1 stored in the register 28b to the timer 28a, and start the measurement. Then, the process advances to a step S77 so as to determine whether or not a power-on request has been issued to the main device from the sub CPU 34. If YES is determined in the step S77, the process advances to a step S79 so as to control the power of the battery 30 or the external power-supply 42 such that the current mode, which is the power-supply sleeping state, is transitioned to the main-power-supply supplying state. Then, the process returns to the step S71.

If NO is determined in the step S77, the process advances to a step S81 so as to determine whether or not the timer 28a has reached time-up, and if NO is determined, the process returns to the step S77. If YES is determined in the step S81, the process advances to a step S83 so as to control the power of the battery 30 or the external power-supply 42 such that the memory-power-supply supplying state is transitioned to the power-supply sleeping state. Then, the process advances to a step S85 so as to determine whether or not a power-on request has been issued to the main device from the sub CPU 28. The determination is repeated until YES is determined, and if YES is determined, the process advances to a step S79.

As described above, according to this embodiment, in a case where any trigger that may result in the power-off occurs to the operating digital camera 10, a period during which the firmware is preventing from becoming volatile, which would occur if the firmware executed by the main CPU 22 at the time that the digital camera 10 is activated next time is developed from the non-volatile memory 26 so that the power supply is provided to the stored volatile memory 24, is differed depending on the mode of the trigger. Therefore, it is possible to optimize a balance between shortening the activation time of the digital camera 10 and inhibiting an unnecessary power supply depending on a user's usage and the like.

It is noted that in this embodiment, the control such that the current state is transitioned from the main-power-supply supplying state through the memory-power-supply supplying state to the power-supply sleeping state as a result of the power-off manipulation or the sleep operation being performed is realized by respectively executing a program developed from the nonvolatile memory 26 to the volatile memory 24 by using microcomputers (not shown) of the main CPU 22, the sub CPU 34, and the power-supply control portion 28. However, this control may be processed by a single CPU, and may also be processed in a distributed manner by further providing other CPUs or microcomputers.

Although the present invention has been described in terms of the digital camera 10 in this embodiment, the invention is not limited to the digital camera 10, but may be applied to an IC recorder, a digital photo frame, a music reproduction music player, a television, and the like. In this case, for example, the lens 16, the CMOS imager unit 18, the signal processing circuit 20, and the LCD 38 of this embodiment are substituted with functions of each device.

Although the description has been provided by using the CMOS imager unit 18 as the image-pickup element in this embodiment, a CCD imager may be employed instead of the CMOS imager.

Although an internal memory (not shown) in the digital camera 10 is employed as a device for recording a still image file and a moving image file according to this embodiment, devices such as a detachable external memory card, an HHD, and an optical disc may be applied.

Moreover, in this embodiment, although the power-supply managing task, the sleep transition task, the power-feeding-time calculating task, and the power-supply control task are executed using the sub CPU 34, the main CPU 22, and the power-supply control portion 28 by applying soft-processing, one or all of these may be executed through hard-processing.

Furthermore, in this embodiment, although the image signal based on the digital image signal is displayed on the LCD 38, an organic EL may be applied to display the image signal.

Although the present invention has been described and illustrated in detail, it is clearly understood that the same is by way of illustration and example only and is not to be taken by way of limitation, the spirit and scope of the present invention being limited only by the terms of the appended claims.

### REFERENCE SIGNS LIST

10 . . . digital camera
22 . . . main CPU
24 . . . volatile memory
26 . . . nonvolatile memory
28 . . . power-supply control portion
30 . . . battery
32 . . . SDRAM
36 . . . manipulation portion
42 . . . external power supply

1. An electronic apparatus, comprising:
a volatile memory which stores operation information for operating an apparatus main body,
a power feeder which feeds first power for retaining the operation information stored in said volatile memory and second power for maintaining an operation state to the apparatus main body;
a request receiver which receives a non-operation state request for moving the apparatus main body from the operation state to a non-operation state in which one portion of the apparatus main body is not operated;
a power supply controller which controls said power feeder such that the first power only is fed for a predetermined period when the non-operation state request is received by said request receiver;
a mode determiner which determines a mode of the non-operation state request; and
a setter which sets the predetermined period depending on the mode determined by said mode determiner.

2. An electronic apparatus according to claim 1, further comprising:
a first manipulation receiver which receives a first manipulation for causing the apparatus main body to perform a predetermined operation;
a first request issuer which issues the non-operation state request as a first request mode, when receiving the manipulation by said first manipulation receiver is not performed for a predetermined period;
a second manipulation receiver which receives a second manipulation for bringing the apparatus main body in the non-operation state; and
a second request issuer which issues the non-operation state request as a second request mode, when the manipulation by the second manipulation receiver is received, wherein
said setter sets the predetermined period longer than a predetermined period that is when the mode determined by said mode determiner is the second request mode, when the mode determined by said mode determiner is the first request mode.

3. An electronic apparatus according to claim 1, further comprising a voltage detector which detects voltage levels of power supplies of the first power and the second power fed by said power feeder, wherein
said setter sets the predetermined period according to the voltage level detected by the mode and said voltage detector.

4. An electronic apparatus according to claim 1, further comprising a time measurer which measures a current time, wherein
said setter sets the predetermined period according to the mode, the voltage level, and the time detected by said time measurer.
